(19) United States
(12) Patent Application Publication
(10) Pub. No.: US 2025/0136406 A1
(43) Pub. Date: May 1, 2025

(54) Backwash Hose Reel Directly Supportable on a Pool Filter

(71) Applicant: David Edward Connor, London (CA)

(72) Inventor: David Edward Connor, London (CA)

(21) Appl. No.: 18/909,666

(22) Filed: Oct. 8, 2024

Related U.S. Application Data
(60) Provisional application No. 63/593,783, filed on Oct. 27, 2023.

(51) Int. Cl. B65H 75/42; C02F 1/00; C02F 103/42; E04H 4/12

(52) U.S. Cl. CPC B65H 75/42; C02F 1/001; E04H 4/1218; C02F 2103/42; C02F 2303/16

(57) ABSTRACT

A reel for storing a backwash hose used in backwash cleanout of a filter. The reel has a hub for wound for storage of the hose, and radiating front and rear flanges for capture of the hose therebetween. A combined support and intake coupler that protrudes axially rearward from the hub, and relative to which the hub is rotatable, terminates in a pipe thread by which the combined coupler is couplable to the waste port of the filter to both fluidly connect the reel and hose thereto, and also mechanically support the reel on the filter. A built-in relief valve resides at a location of fluidically exposed relationship both to the combined coupler and to a hose coupler, such that in the event of flow blockage somewhere along the backwash hose, pressure buildup upstream of the backwash hose is operable to open said relief valve and relieve the hose pressure buildup.

### CROSS-REFERENCE TO RELATED APPLICATIONS

This application claims benefit under 35 U.S.C. 119 (e) of U.S. Provisional Application No. 63/593,783, filed Oct. 27, 2023, the entirety of which is incorporated herein by reference.

### FIELD OF THE INVENTION

The present invention relates generally to swimming pool equipment, and more particularly to the storage of a backwash hose used during backwash cleanout of a pool filter.

### BACKGROUND

As will be familiar to those with residential swimming pools, and to those that work in swimming pool environments or in the swimming pool equipment supply industry, one step involved in the proper maintenance of a swimming pool is periodic cleanout of a pool filter found in a circulation system of the pool. In normal operation, a pump of this circulation system continuously pumps a stream of pool water from pool, through the pool filter, and then back into the pool. To instead perform a cleanout of the pool filter, a multi-port adjustable valve setup of the pool filter is temporarily switched from a default circulation setting, which that routes the pool water through the filter in a first direction and then back to the pool via a recirculation outlet of the valve setup, to a backwash setting, which instead routes the pool water through the filter in an opposing second direction and then out through a waste port of the valve setup. Through such backwashing of the of filter, particulate buildup that has accumulated therein is dislodged, and instead of being circulated back into the pool, is discharged through the waste port with the backwashing stream of pool water. Typically, this contaminant-carrying backwash stream is pumped some reasonable distance (e.g. 25 to 100 feet) away from the pool equipment through a backwash hose that is temporarily coupled to the waste port of the pool filter valve setup. The backwash hose is typically decoupled from the waste port after the backwashing cleanout is complete, and often coiled up by hand and then stored away at some separate location (e.g. storage shed, garage, basement, etc.) until the next time it is needed.

To ease the process of coiling of the backwash hose for storage, others have previously proposed or commercialized backwash hose reels to and from which the backwash hose can be wound and unwound for storage and use. Commercialized examples include small handheld backwash hose reels, that are merely used to help with the winding and unwinding of the hose between use and storage thereof, and involve full removal of the backwash hose reel therefrom in preparation for the backwash cleanout process. Other than aiding in the winding and unwinding of the backwash hose, these existing reels have no effect on other steps of the conventional process, in terms of coupling and decoupling the backwash hose to the valve setup of the filter before and after use, and storing the reel and hose combination in a shed or other remote location between uses. In published US Patent Application US2005/0092696 disclosure of a similar hand-carried backwash hose reel was accompanied by disclosure of a wheeled backwash hose reel, which was described as also being usable to help with the drainage of the backwash hose reel before re-winding thereof onto the reel for storage. The reels in that application were again of a character involving full removal of the hose from reel as part of the backwash preparation, and involved carrying/rolling of the reel from the filter-connected end of the hose out to the deployed free end of the hose, from which the hose was then rewound.

In summary, these prior backwash hose reel designs offered little improvement over the conventional approach to deployment and storage and a pool filter backwash hose, for which there remains a desire for a more eloquent solution. Applicant has developed a novel backwash hose reel design that addresses these shortcomings, and also possess other beneficial novelties not heretofore seen.

### SUMMARY OF THE INVENTION

According to a first aspect of the invention, there is provided a backwash hose reel for storing a backwash hose used to route waste flow from a waste port of a filter during a backwash cleanout of said filter, said backwash hose reel comprising:
a hub around which said backwash hose can be wound for storage on the backwash hose reel, and which is rotatable about a central axis of said hub;
a front flange of outwardly radiating relationship to said hub at or adjacent a front end thereof, and a rear flange of outwardly radiating relationship to said hub at or adjacent an opposing rear end thereof for capture of the backwash hose, when in wound storage on the hub, between said front and rear flanges; and
a combined support and intake coupler that protrudes axially from the hub at the rear side thereof, and relative to which the hub is rotatable about said central axis, said combined support and intake coupler terminating in a pipe thread by which the combined support and intake coupler is threadingly couplable to the waste port of the filter to both fluidly connect the backwash hose reel thereto, for fluidic feed of the backwash hose from the waste port of the filter via the backwash hose reel, and also mechanically support the backwash hose reel on the filter for selectively deployable stowage of the backwash hose thereon by the hub, whose rotatability in opposing directions about the central axis is usable in selective unwinding of the backwash hose from the hub for use, and re-winding of the backwash hose around the hub for storage between uses.

According to a second aspect of the invention, there are provided, in combination, a filter having a waste port for discharge of waste water therefrom during a backwash cleanout of said filter, and a backwash hose reel for wound support thereon of a backwash hose through said waste water is dispersible during said backwash cleanout of the filter, wherein the backwash hose reel comprises an intake coupler by which the backwash hose reel is fluidically coupled or couplable to the waste port of the filter for both in-situ storage of the backwash hose locally of the filter, in said wound support on the hose reel, at times between periodic repetitions of said backwash cleanout, and for fluidic feeding of the backwash hose from the waste port through the backwash hose reel during said periodic repetitions of said backwash cleanout.

Preferably, the backwash hose reel is physically coupled to the filter in a state supported entirely and solely thereby in an elevated position out of ground contact.

According to a third aspect of the invention, there is provided a method of storing a backwash hose for a filter, said method comprising storing said backwash hose in a wound state on a backwash hose reel that is fluidically coupled to a waste port of the filter for both in-situ storage of the backwash hose locally of the filter, in said wound state on the hose reel, at times between periodic backwash cleanouts of said filter, and for fluidic feeding of the backwash hose from the waste port through the backwash hose reel during said periodic backwash cleanouts.

According to a fourth aspect of the invention, there is provided a backwash hose reel for storing a backwash hose used to route waste flow from a waste port of a filter during a backwash cleanout of said filter, said backwash hose reel comprising:
a hub around which said backwash hose can be wound for storage on the backwash hose reel, and which is rotatable about a central axis of said hub;
a front flange of outwardly radiating relationship to said hub at or adjacent a front end thereof, and a rear flange of outwardly radiating relationship to said hub at or adjacent an opposing rear end thereof for capture of the backwash hose, when in wound storage on the hub, between said front and rear flanges; and
an intake coupler with a pipe thread by which the intake coupler is threadingly couplable to the waste port of the filter to fluidly connect the backwash hose 5 reel thereto;
a hose coupler on the hub operable to receive coupled connection of an inlet end of the backwash hose in a manner both mechanically coupling the inlet end of the backwash hose to the hub and fluidically communicating the inlet end of the backwash hose to the intake coupler; and
a relief valve of fluidically exposed relationship both to the intake coupler and to the hose coupler, such that in the event of flow blockage somewhere along the backwash hose, pressure buildup upstream of the backwash hose is operable to open said relief valve and release said pressure buildup.

### BRIEF DESCRIPTION OF THE DRAWINGS

One or more preferred embodiments of the invention will now be described in conjunction with the accompanying drawings in which:

FIG. 1 is a top front perspective view of a backwash hose reel of the present invention.

FIG. 2 is a top plan view of the backwash hose reel of FIG. 1.

FIG. 3 is a front elevational view of the backwash hose reel of FIG. 1.

FIG. 4 is a side elevational view of the backwash hose reel of FIG. 1.

FIG. 5 is a cross-sectional view of the backwash hose reel of FIG. 3, as viewed along line A-A thereof.

FIG. 6 is an isolated front elevational view of a hub of the backwash reel.

FIG. 7 is a cross-sectional view of the hub of FIG. 6 as viewed along line C-C thereof.

FIG. 8 is an isolated top rear perspective view of a combined support and intake coupler of the hose reel.

FIG. 9 is an isolated rear elevational view of a rear flange of the backwash hose reel of FIG. 1.

FIG. 10 is an isolated front elevational view of a front flange of the backwash hose reel of FIG. 1.

FIG. 11 is a side elevational view of the backwash hose reel of FIG. 1 installed on a swimming pool filter for use in cooperative relation thereto during backwash cleanout of the swimming pool filter.

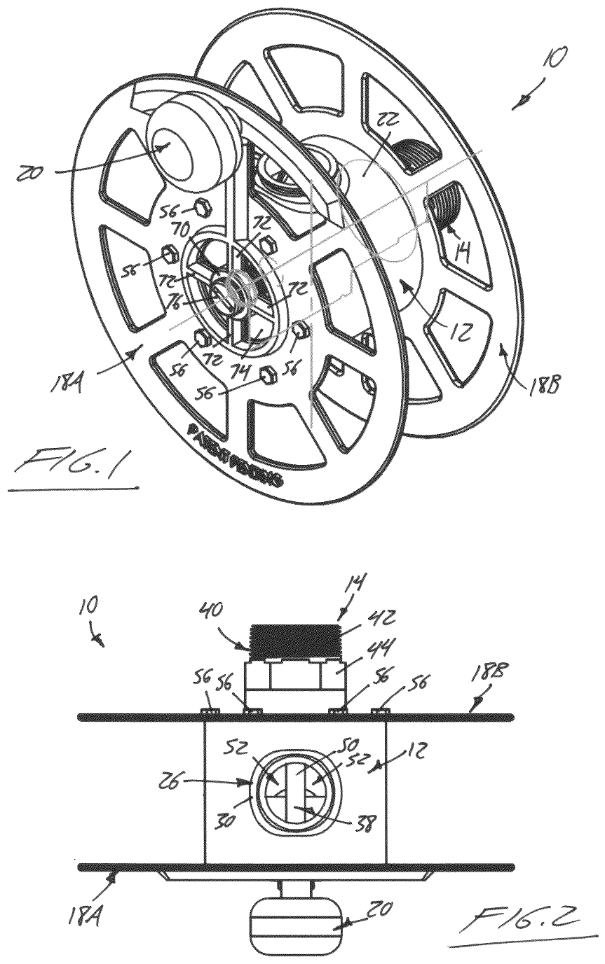

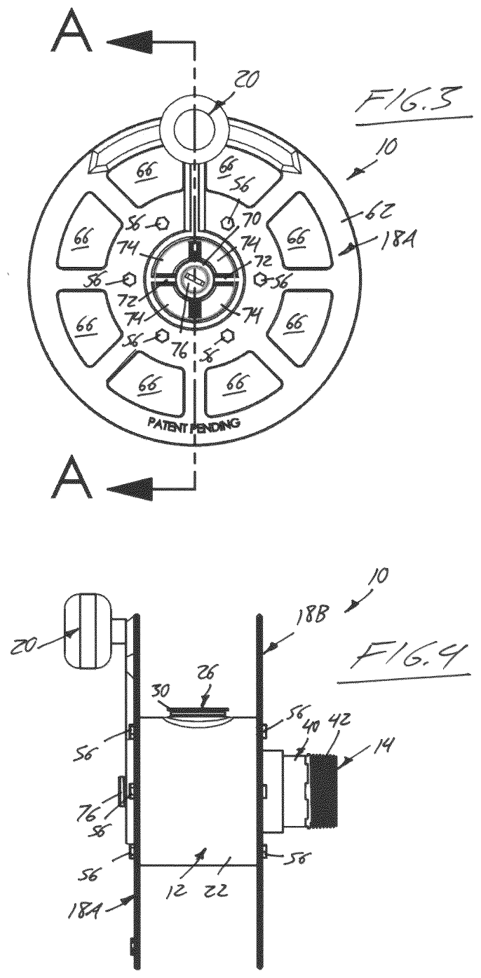

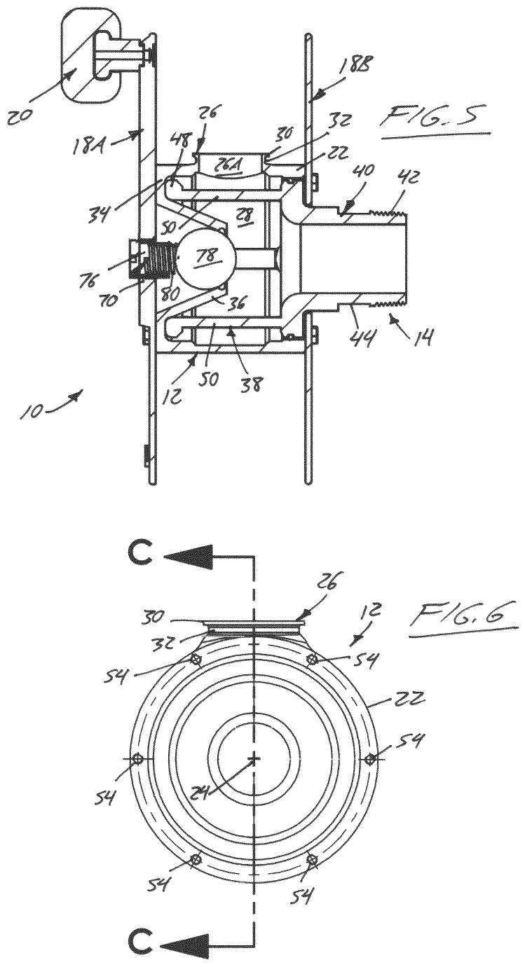

### DETAILED DESCRIPTION

As summarized briefly above, the appended drawings illustrate an inventive backwash hose reel 10 for storing a backwash hose for a swimming pool filter, which differs from other existing hose reels in that the hose reel is specifically designed for mounting thereof onto the swimming pool filter 100 itself, as illustrated specifically in the environmental view of FIG. 11. This way, a backwash hose (not shown) installed on the backwash hose reel is conveniently stored directly at the same location as the pool filter 100, and is easily deployed for use when needed for backwash cleanout of the pool filter, and easily retracted into a neatly wound coil on the reel 10 once the backwash cleanout is complete, through simple rotation of the reel. The installed reel 10 and hose take up no storage footprint in a shed, garage, basement, or other remote storage site, and require no conveyance back and forth between the storage site and the pool filter location, and are therefore less likely to be misplaced.

The reel 10 is composed of a relatively small quantity of constituent parts, namely a rotatable hub 12 onto which the backwash hose is wound for coiled storage thereon, a combined support and intake coupler 14 for mechanically and fluidly coupling the backwash hose reel 10 to the swimming pool filter 100 at a backwash waste port 102 thereof in a manner rotatably supporting the hub 12 on the swimming pool filter 100, front and rear flanges 18A, 18B attached at opposing front and rear ends of the hub 12 in aligned positions radiating outwardly from the hub to capture the backwash hose between these flanges 18A, 18B when wound around the hub 12 for coiled storage thereon, and an operating handle 20 installed on the front flange 18A for use in manually driven rotation of the hub 12 around the combined support and intake coupler 14 in a direction winding the backwash hose onto the hub 12.

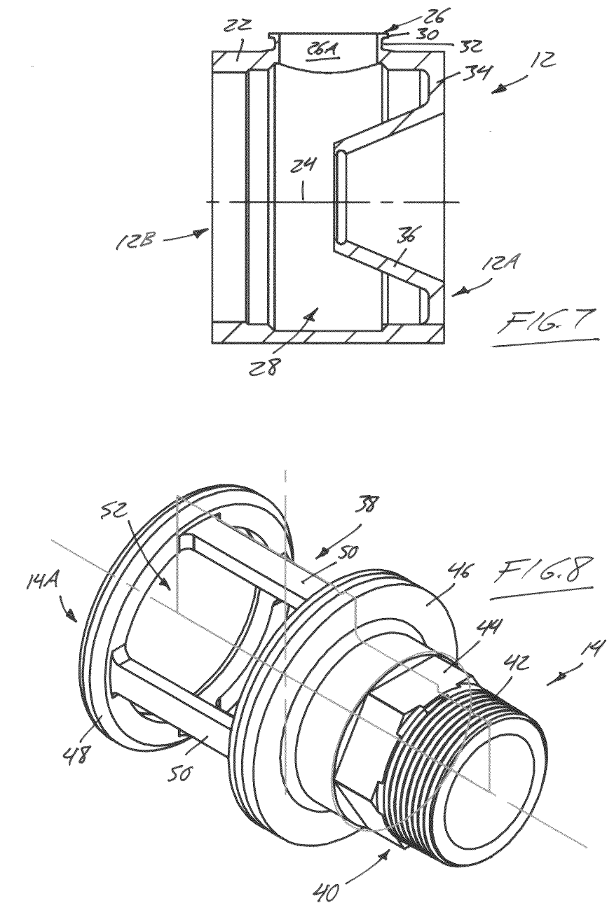

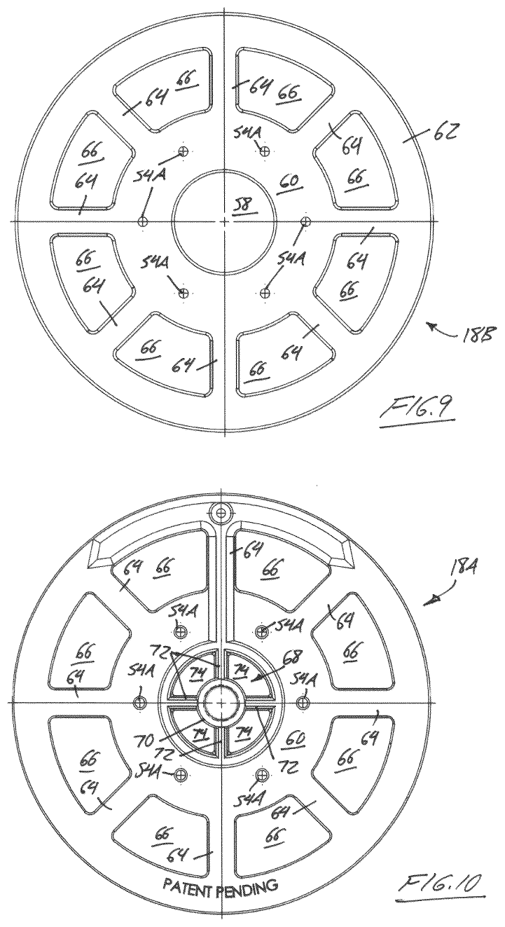

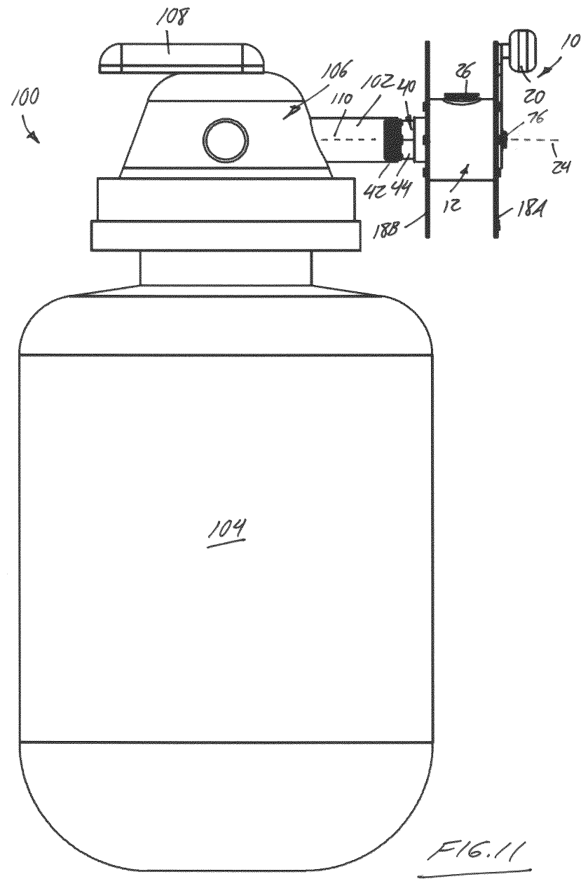

The hub 12, shown in isolation in FIGS. 6 and 7, has a drum-shaped peripheral wall 22 around which the backwash hose is wound in a coiled state spanning circumferentially therearound. A central axis 24 of the hub denotes a radial center of the drum-shaped peripheral wall 22, and it is around this central axis 24 that the hub 12 of the assembled hose reel 10 is rotatable. The drum-shaped peripheral wall 22 is substantially cylindrical in exterior form, deviating from such cylindrical character only at a coupling stem 26 of radially protruding relation to the drum-shaped peripheral wall 22 at a singular point around the drum's circumference. The coupling stem 26 is a hollow stem characterized by an internal stem bore 26A penetrating axially through the stem and radially through the drum-shaped peripheral wall 20 into an internal chamber 28 of the hub 12 that is circumferentially bound by an interior of the drum-shaped peripheral wall 22.

At a free end of the coupling stem 26 situated distally of the drum-shaped peripheral wall 22, the coupling stem 26 is characterized by an enlarged shoulder 30 of greater diameter than a reduced neck 32 of the coupling stem 26 that resides between the enlarged shoulder 30 and the exterior of the drum-shaped peripheral wall 22. This reduced neck 32 accommodates clamped capture of an inlet end of the backwash hose to the coupling stem 26 using a zip tie, pipe clamp, or other clamping fastener capable of clamping the inlet end of the backwash hose around the coupling stem 26. Under such connection of the inlet end of the backwash hose to the coupling stem 26, the interior conduit of the backwash hose is fluidly communicated with the internal chamber 28 of the hub 12 through the stem bore 26A. With the inlet end of the backwash hose coupled to the coupling stem 26 of the rotatable hub 12, rotation of the hub 12 in one direction is operable to wind the backwash hose around the hub 12, while pulling of the hose in a direction of reverse relation to such winding is operable to rotate the hub 12 in a reverse direction unwinding the backwash hose therefrom into a suitably deployed state for routing waste water from the backwash cleanout 102 of the swimming pool filter 100 to a final discharge point.

Referring to FIG. 7, the internal chamber 28 is fully open at a rear end 12B of the hub 12 over a full internal diameter of the drum-shaped peripheral wall 22. At an opposing front end 12A of the hub 12, the internal chamber 28 is instead capped off by the combination of an annular flange 34 of in-turned relation to a front end of the drum-shaped peripheral wall 22, and a frustoconical interior wall 36 that juts axially into the internal chamber 28 from a radially inner end of the in-turned annular flange 34. This frustoconical interior wall 36 is centered on the central axis 24, and tapers inwardly theretoward in its rearward reach toward the rear end 12B of the hub. The axial length of the frustoconical interior wall 36 is less than the axial length of the drum-shaped peripheral wall 22, whereby the frustoconical interior wall 36 terminates somewhere within the internal chamber 28 at an axial distance from the open rear end 12B of the hub, for example at or near a midplane of hub 12 situated midway between the front and rear ends thereof, which midplane may contain both this terminal end of the frustoconical interior wall 36 and a radial axis on which the coupling stem 26 is centered.

The combined support and intake coupler 14 is assembled with the hub 12 in a manner in which the intake coupler 14 is partially contained within the internal chamber 28 of the hub 12, but is also of externally and axially protruding relation to the hub at the rear end 12B thereof. The portion of the combined support and intake coupler 14 contained within the internal chamber 28 of the hub 12 is referred to as an internal body 38 of the combined support and intake coupler 14, while the portion protruding externally of the hub 12 is referred to as an external neck 40 of the combined support and intake coupler 14. The external neck 40 is characterized by the inclusion of pipe threading 42 at a terminal rear end thereof that resides axially distal of the internal body 38. In the assembled state of the hose reel, the hub 12 and the combined support and intake coupler 14 shared the same central axis 24, around which the hub 12 is rotatable relative to the combined support and intake coupler 14. As shown, the pipe threading 42 of the external neck of the combined support and intake coupler 14 may be neighboured by a set of wrench flats 44 circumscribing the external neck 40.

The internal body 38 of the combined support and intake coupler 14 features an outer shoulder 46 of annular form and radially outward protruding relation to the external neck 40 at a location denoting a front end of the external neck 40 and a rear end of the internal body 38, or in other words, where the external neck 40 and the internal body 38 join together. At an opposing front end of the internal body 38, which denotes the corresponding front end 14A of the overall coupler 14, the internal body 38 features an end ring 48 dimensioned for receipt thereof against, or closely adjacent, the interior face of the in-turned annular flange 34 at the closed front end of the internal chamber 28 of the hub. In the assembled state of the reel 10, this end ring 48 thus resides in a space between the frustoconical interior wall 36 of the hub and the drum-shaped peripheral wall 22 thereof, as can be seen in FIG. 5. Between the outer shoulder 46 and the end ring 48, the internal body 38 of the combined support and intake coupler 14 is of skeletal form, composed of a plurality of axial struts 50 axially interconnecting the outer shoulder 46 to the end ring 48 at angularly spaced intervals around the central axis 24 (e.g. four struts 50 situated at ninety-degree intervals to one another), whereby a flow window 52 is left open between each neighbouring pair of such axial struts 50 to permit waste water to flow out from the internal body 38 of the combined support and intake coupler 14 into the internal chamber 28 of the hub 12 during a backwash cleanout of the swimming pool filter 100, as described in more detail below.

Each end 12A, 12B of the hub 12 includes a plurality of axially oriented fastening bores 54, for example disposed in the respective annular end of the drum-shaped peripheral wall 22, at angularly spaced locations around the central axis 24 to accommodate fastened attachment of the respective front or rear flange 18A, 18B to the hub 12 using a respective set of threaded fasteners 56, for each flange 18A, 18B has a matching set of fastening apertures therein for alignment with the respective set of fastening bores 54 in the respective end of the hub 12. A circular outer perimeter of each flange 18A, 18B is centered on the same central axis 24 also shared by the hub 12 and the combined support and intake coupler 14. In other embodiments, use of threaded fasteners for attachment of the flanges to the hub may be substituted for an alternative means of attachment, for example using snap-fit features on each flange alignable and matable with corresponding snap-fit features on the hub for fastener-free assembly of the flanges to the hub.

Rear flange 18B has a central hole 58 therein that, in the assembled state of the hose reel 10, shares the same central axis 24 as the hub 12 and the combined support and intake coupler 14. The central hole 58 of the rear flange 18B is sized large enough to accommodate passage therethrough of the exterior neck 40 of the combined support and intake coupler 14, but small enough to block passage of the outer shoulder 46 of the internal body through the central hole 58. During assembly of the backwash hose reel 10, the rear flange 18B is fastened to the rear end 12B of the hub 12 after the internal body 38 is inserted into the internal chamber 28 of the hub 12, with the result that a radially inner region of the rear flange 18B of radially adjacent and circumferentially surrounding relation to the central hole 58 (as embodied by an inner margin of the inner web 60 described below, in the illustrated instance of a spoked flange) axially overlies the outer shoulder 46 of the internal body 38 in order to capture the internal body 38 within the internal chamber 28 of the hub 12, thereby retaining the hub 12 and the combined support and intake coupler 14 in assembled relation to one another. In this assembled relationship, the hub 12 is rotatable around the internal body 38 of the combined support and intake coupler 14 on the central axis 24 shared by these two components.

In the illustrated example, each flange 18A, 18B has a spoked shape, with an annular inner web 60 having fastening apertures 54A of matching layout to the fastening bores 54 of the hub 12 for fastened attachment of the annular inner web 60 to the hub 12, an annular outer rim 62 of surrounding and radially larger relation to the annular inner web 60, and a plurality of spokes 64 radiating outwardly from the inner web 60 to the outer rim 62 between a plurality of flange openings 66 delimited between the spokes. That said, each flange could alternatively lack such spokes and openings 64, 66, and instead resemble a more intact disc of solid form between its fastened attachment to the hub and its outer perimeter.

The front flange 18A also has a central opening 68 centered on the shared central axis, but this central opening 68 is not an entirely open round hole like the central hole 58 of the rear flange 18B that needs to be fully open to accommodate the exterior neck 40 of the combined support and intake coupler 14. Instead, an internally threaded collar 70 is supported in the central opening 68 in likewise centered relation on the shared central axis 24 by a plurality of radial support struts 72 that link this internally threaded collar 70 to the perimeter of the central opening 68. Relief valve apertures 74 are left open between these support struts 72 for reasons that will become apparent further below. The internally threaded collar 70 receives therein an externally threaded adjustment screw 76 for adjusting a relief pressure of a relieve valve, of which the frustoconical interior wall 36 of the hub 12 forms a tapered valve seat, against which there is seated a ball-shaped valve member 78, typically formed of rubber or other similarly resilient material. By default, the ball-shaped valve member 78, by way of a compression spring 80 constrained between the adjustment screw 76 and the ball-shaped valve member 78, is normally held in fluidly sealed contact with the interior of the frustoconical interior wall 36 in adjacency to an open inner end thereof that opens into the internal chamber 28 of the hub 12.

The ball-shaped valve member 78 will only be unseated from the frustoconical interior wall 36 when pressure inside the internal chamber 28 of the hub 12 exerts a force on the ball-shaped valve member 78 that overcomes the spring force of the compression spring 80. The adjustment screw 76 enables adjustment of this relief pressure at which the relief valve will open, by controlling the degree to which the compression spring 80 is pre-compressed, thereby affecting the spring force exerted thereby against the ball-shaped valve member 78. When fluid pressure inside the internal chamber 28 exceeds the relief pressure, the ball-shaped valve member 78 is forced forwardly out of seated contact with the frustoconical interior wall 36 of the hub 12, thus opening up the inner end of this frustoconical interior wall 36, through which fluid inside the internal chamber 28 of the hub 12 can escape to the exterior environment outside the hub 12 through the relief valve apertures 74 in the front flange 18A.

Having described the structure of the hose reel 10, attention is now turned to its installation and use. FIG. 11 shows a conventional swimming pool filter 100, with a cannister 104 containing a filtration media therein, and a valve head 106 installed atop the cannister 104 and containing the necessary valving for routing pool water through the filtration media in the cannister 104, both in the default circulation mode of operation and the backwash mode for cleanout of the filtration media, as described in the background given above. The valve head 106 includes a movable control lever 108 that is pivotal between different operational positions, including at least a default circulation position placing the valving in the default circulation setting, and a backwash cleanout position placing the valving in the backwash setting. Using the pipe threading 42 on the neck 40 of the combined support and intake coupler 14, the backwash hose reel 10 is coupled to the waste port 102 of the valve head 106 through which waste water is dispensed during operation of the swimming pool circulation system in backwash mode. Such coupling may be a direct coupling if the pipe threading 42 is of matching specification and of reverse male or female relation to existing threading of the waste port 102, or an indirect coupling using one or more threaded adapter fittings.

Via such coupling, the combined support and intake coupler 14 both mechanically supports the inventive backwash hose reel 10 on the swimming pool filter 100 in a manner supported solely thereby, in a position elevated out of ground contact to allow rotation of the hub 12 and attached front and rear flanges 18A, 18B of the backwash hose reel 10 around the combined support and intake coupler 14. In the illustrated example, the combined support and intake coupler 14 is of linear character spanning along the central axis 24 with no deviation therefrom, whereby the pipe threading 42 is centered on this same central axis 24, with the result that coupling of the combined support and intake coupler 14 to the waste port 102 of the swimming pool filter 100 either directly, or using only one or more straight in-line adapter fittings, places the central axis 24 coincident with a horizontal axis 110 of the waste port 102 of the pool filter 100. That said, the combined support and intake coupler 14 need not necessarily be linear, nor is the hose reel's installation conditional on using only straight in-line adapter fittings, provided that the resulting installed elevation of the hose reel 10 leaves sufficient clearance space around the reel 10 to permit unobstructed rotation of the installed hose reel 10 about its central axis 24.

Before or after the installation of the hose reel 10, a backwash hose (not shown) is coupled to the hub 12 of the hose reel 10 at the coupling stem 26 thereof, in the clamped fashion already described above, thereby placing the interior conduit of the backwash hose in fluid communication with the waste port 102 of the swimming pool filter 100 via a flow path through the external neck 40 and skeletal interior body 38 of the combined support and intake coupler 14 and the internal chamber 28 of the hub 12. The relief valve, whose valve member 78 is seated where the frustoconical interior wall 36 opens into the internal chamber 28 of the hub, thus resides in fluid communication with this flow path from the waste port 102 to the coupled inlet end of the backwash hose. Between backwash cleanouts of the swimming pool filter 100, the backwash hose is simply stored in a wound state on the hub 12 of the backwash hose reel 10 that is physically supported entirely and solely by the swimming pool filter 100, denoting in-situ storage of the backwash hose directly at the pool filter 100 in a manner conveniently dispensable therefrom any time a backwash cleanout is necessary or advisable, at which time the backwash hose is simply unwound into a deployed state via pulling of the discharge end of the coiled backwash hose from the reel 10, thereby imparting rotational movement to the reel hub 12 in a direction unwinding the backwash hose therefrom, owing to the coupled state of the inlet end of the backwash hose to the coupling stem 26 of the hub 12. With the backwash hose so deployed, the valve control lever 108 of the swimming pool filter 100 is switched to the backwash cleanout position, and the associated pump (not shown) is activated to pump pool water through the filtration media in a direction of reverse relation to the normal circulation mode, and out through the waste port 102, and thus into the backwash hose via the combined support and intake coupler 14 and the internal chamber 28 of the hub 12. Should a kink or other obstruction block discharge of the waste water through the backwash hose, fluid pressure will build up inside the internal chamber 28 of the hub 12, and thus force open the relief valve, whereupon the pumped waste water can safely discharge through the relief valve openings 74 in the front flange 18A of the backwash hose reel 74, thereby preventing any equipment damage owing to obstruction-induced pressure buildup. While described in the context of a swimming pool filter, any other filter types similarly equipped with a backwash capable valve setup and associated waste port may likewise form an operating environment for the present invention.

While the illustrated embodiment is particular efficient in its parts count by making reliance on the pool filter itself as the supportive structure for holding the rotatable hub in an elevated state out of ground contact in close local adjacency to the pool filter, it will be appreciated that in the other embodiments, the backwash hose reel could instead embody its own supportive framework for holding the rotatable hub in an elevated and rotatable state up of the ground, in which instance the intake coupler 14 is still used to make the fluidic connection of the backwash hose reel to the waste port, via threaded connection of hard piping or flexible hose therebetween, for similar purposeful result of local in-situ storage of the backwash hose in close local adjacency to the pool filter, with the reel wound backwash hose residing in ready fluidic communication with the waste port at all times, through the hose reel.

Since various modifications can be made in the invention as herein above described, and many apparently widely different embodiments of same made, it is intended that all matter contained in the accompanying specification shall be interpreted as illustrative only and not in a limiting sense.

1. A backwash hose reel for storing a backwash hose used to route waste flow from a waste port of a filter during a backwash cleanout of said filter, said backwash hose reel comprising:
a hub around which said backwash hose can be wound for storage on the backwash hose reel, and which is rotatable about a central axis of said hub;
a front flange of outwardly radiating relationship to said hub at or adjacent a front end thereof, and a rear flange of outwardly radiating relationship to said hub at or adjacent an opposing rear end thereof for capture of the backwash hose, when in wound storage on the hub, between said front and rear flanges; and
a combined support and intake coupler that protrudes axially from the hub at the rear side thereof, and relative to which the hub is rotatable about said central axis, said combined support and intake coupler terminating in a pipe thread by which the combined support and intake coupler is threadingly couplable to the waste port of the filter to both fluidly connect the backwash hose reel thereto, for fluidic feed of the backwash hose from the waste port of the filter via the backwash hose reel, and also mechanically support the backwash hose reel on the filter for selectively deployable stowage of the backwash hose thereon by the hub, whose rotatability in opposing directions about the central axis is usable in selective unwinding of the backwash hose from the hub for use, and re-winding of the backwash hose around the hub for storage between uses.

2. The backwash hose reel of claim 1 wherein the combined support and intake coupler is a sole supportive component of the backwash hose reel by which the hub is rotatably supportable in a working position rotatable about the central axis.

3. The backwash hose reel of claim 1 wherein the combined support and intake coupler is of non-deviating relationship to the central axis, and remains centered thereon over a full length of combined support and intake coupler from the hub to the pipe threading, which is also centered around said central axis, whereby the central axis is coincident with an axis of the outlet port of the filter when coupled thereto directly by the pipe thread, or via an in-line adapter installed in-line between the outlet port and the combined support and intake coupler.

4. The backwash hose reel of claim 1 wherein the hub has a drum-shaped peripheral wall, an exterior of which receives wound storage of the backwash hose thereon, and an interior of which delimits an internal chamber of the hub into which waste flow from the waste port of the filter is directed by the combined support and intake coupler during the backwash cleanout.

5. The backwash hose reel of claim 4 wherein the combined support and intake coupler comprises an external neck that axially protrudes from the hub and on which the pipe threading is defined, and an internal body captured inside the hub to make mechanical and fluidic coupling thereto, around which internal body the hub is rotatable.

6. The backwash hose reel of claim 5 wherein the internal body of the combined support and intake coupler is captured inside the hub by the front flange.

7. The backwash hose reel of claim 6 wherein the combined support and intake coupler has an outer shoulder where the external neck and the internal body join together, and a radially inner region of the front flange axially overlies said outer shoulder to capture the internal body within the hub.

8. The backwash hose reel of claim 1 further comprising a relief valve and hose coupler, of which the hose coupler is operable to receive coupled connection of an inlet end of the backwash hose in a manner both mechanically coupling the inlet end of the backwash hose to the hub and fluidically communicating the inlet end of the backwash hose to the combined support and intake coupler, and the relief valve resides at a location of fluidically exposed relationship both to the combined support and intake coupler and to the hose coupler, such that in the event of flow blockage somewhere along the backwash hose, pressure buildup upstream of the backwash hose is operable to open said relief valve and release said pressure buildup.

9. The backwash hose reel of claim 8 wherein said relief valve is installed at the front side of the hub across from the combined support and intake coupling that protrudes from the hub at the rear side thereof.

10. The backwash hose reel of claim 8 wherein a valve seat of said relief valve is defined by the hub, against which a movable valve member of the relief valve is biased to denote a default closed state of said relief valve.

11. The backwash hose reel of claim 10 wherein said valve seat of said relief valve is an inwardly tapered valve seat.

12. The backwash hose reel of claim 10 wherein said valve member is ball-shaped.

13. The backwash hose reel of claim 10 wherein the movable valve member is biased against said valve seat by a biasing component acting between the valve member and the rear flange.

14. The backwash hose reel of claim 8 wherein said relief valve is adjustable to modify a relief pressure at which said relief valve will open.

15. The backwash hose reel of claim 13 wherein the relief valve comprises an adjustment by which a degree of precompression imparted to said compression spring is adjustable, thereby enabling adjustment of a relief pressure at which said relief valve will open.

16. The backwash hose reel of claim 8 wherein the hose coupler comprises an externally protruding coupling stem on the hub in externally protruding relation thereto.

17. The backwash hose reel of claim 1 in combination with said filter, wherein the combined support and intake coupler of the backwash hose reel is mechanically coupled to the waste port of the filter, and the backwash hose reel is thereby supported, in an elevated position lacking any ground contact, solely through coupled relationship thereof to the filter.

18. In combination, a filter having a waste port for discharge of waste water therefrom during a backwash cleanout of said filter, and a backwash hose reel for wound support thereon of a backwash hose through said waste water is dispersible during said backwash cleanout of the filter, wherein the backwash hose reel comprises an intake coupler by which the backwash hose reel is fluidically coupled or couplable to the waste port of the filter for both in-situ storage of the backwash hose locally of the filter, in said wound support on the hose reel, at times between periodic repetitions of said backwash cleanout, and for fluidic feeding of the backwash hose from the waste port through the backwash hose reel during said periodic repetitions of said backwash cleanout.

19. A method of using the combination of claim 18, said method comprising storing said backwash hose in a wound state on the backwash hose reel in an installed state thereof fluidically coupled to the waste port of the filter for both said in-situ storage of the backwash hose locally of the filter, in said wound state on the hose reel, at said times between said periodic backwash cleanouts of said filter, and for said fluidic feeding of the backwash hose from the waste port through the backwash hose reel during said periodic backwash cleanouts.

20. A backwash hose reel for storing a backwash hose used to route waste flow from a waste port of a filter during a backwash cleanout of said filter, said backwash hose reel comprising:
a hub around which said backwash hose can be wound for storage on the backwash hose reel, and which is rotatable about a central axis of said hub;
a front flange of outwardly radiating relationship to said hub at or adjacent a front end thereof, and a rear flange of outwardly radiating relationship to said hub at or adjacent an opposing rear end thereof for capture of the backwash hose, when in wound storage on the hub, between said front and rear flanges; and
an intake coupler with a pipe thread by which the intake coupler is threadingly couplable to the waste port of the filter to fluidly connect the backwash hose reel thereto;
a hose coupler on the hub operable to receive coupled connection of an inlet end of the backwash hose in a manner both mechanically coupling the inlet end of the backwash hose to the hub and fluidically communicating the inlet end of the backwash hose to the intake coupler; and
a relief valve of fluidically exposed relationship both to the intake coupler and to the hose coupler, such that in the event of flow blockage somewhere along the backwash hose, pressure buildup upstream of the backwash hose is operable to open said relief valve and release said pressure buildup.
